(19) United States
(12) Patent Application Publication
(10) Pub. No.: US 2024/0425225 A1
(43) Pub. Date: Dec. 26, 2024

(54) Container with Internal Ribs

(71) Applicant: BWAY Corporation, Atlanta, GA (US)

(72) Inventor: Josef BINGISSER, Lagrange, GA (US)

(21) Appl. No.: 18/825,462

(22) Filed: Sep. 5, 2024

Related U.S. Application Data
(63) Continuation of application No. PCT/US2022/019074, filed on Mar. 7, 2022.

(51) Int. Cl. B65D 1/40; B29D 22/00; B29K 67/00; B65D 1/16

(52) U.S. Cl. CPC B65D 1/40; B29D 22/003; B65D 1/16; B29K 2067/003

(57) ABSTRACT

A container including a bottom comprising a bottom surface and a bottom perimeter, the bottom perimeter a first distance from a central axis of the bottom surface; a sidewall extending vertically from the bottom perimeter at the first distance from the center of the bottom surface to a container bead at a second distance from the central axis of the bottom surface, wherein the sidewall comprises: an outside surface of the sidewall; and an interior surface of the sidewall, the interior surface comprising a plurality of vertical ribs extending vertically from the bottom perimeter, wherein each vertical rib of the plurality of vertical ribs comprises: a first vertical arc cut to form a first side of the vertical rib; and a second vertical arc cut to form a second side of the vertical rib opposite the first side of the vertical rib.

### CROSS REFERENCE TO RELATED APPLICATIONS

This application is a bypass continuation application claiming priority to, and the benefit of, International Patent Application No. PCT/US2022/019074, filed on Mar. 7, 2022, and entitled “CONTAINER WITH INTERNAL RIBS,” the disclosure of which is incorporated by reference as if the same was fully set forth herein.

### TECHNICAL FIELD

The present disclosure relates generally to containers.

### BACKGROUND

Containers are an essential tool in everyday activities. Containers can be used in a multitude of scenarios for a wide variety of purposes. For example, containers have been used to store liquids, solids, and gases across a wide range of industries. Because of the prevalence of the component for manufacturers and retailers, improvements to containers may account for significant cost savings to a company's bottom line.

Therefore, there is a long-felt but unresolved need for a system or method for manufacturing a container with reduced material cost while still maintaining the structural integrity of the container.

### BRIEF SUMMARY OF THE DISCLOSURE

Briefly described, and according to one embodiment, aspects of the present disclosure generally relate to containers and methods for manufacturing the containers.

In various embodiments, the container is a conical frustum object with a bottom and a wall. The container may hold any particular object, item, or substance that fits into the container. To reduce the cost of manufacturing, the container may include internal ribs and arc cuts. In some embodiments, the arc cuts reduce the mass of the container by up to ten or more percent while still maintaining the structural integrity of the container.

These and other aspects, features, and benefits of the claimed embodiment(s) will become apparent from the following detailed written description of the preferred embodiments and aspects taken in conjunction with the following drawings, although variations and modifications thereto may be effected without departing from the spirit and scope of the novel concept of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a perspective view of a container, according to one embodiment of the present disclosure;

FIG. 2 illustrates a bottom perspective view of the container of FIG. 1, according to one embodiment of the present disclosure;

FIG. 3 illustrates a top view of the container of FIG. 1, according to one embodiment of the present disclosure;

FIG. 4 illustrates a bottom view of the container of FIG. 1, according to one embodiment of the present disclosure;

FIG. 5 illustrates a first side view of the container of FIG. 1, according to one embodiment of the present disclosure;

FIG. 6 illustrates a second side view of the container of FIG. 1, according to one embodiment of the present disclosure;

FIG. 7 illustrates a first cross-section view of the container of FIG. 1, according to one embodiment of the present disclosure;

FIG. 8 illustrates a second cross-section view of the container of FIG. 1, according to one embodiment of the present disclosure;

FIG. 9 illustrates a cross-section view of an example bottom of the container of FIG. 1, according to one embodiment of the present disclosure; and

FIG. 10 illustrates a flowchart of a process depicting a method of manufacturing the container, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with, and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to containers and methods for manufacturing containers with internal ribs. In various embodiments, the container is a conical frustum object with a bottom and a wall. The container may hold any particular object, item, or substance that fits into the container. To reduce the amount of material used in the containers, to reduce the mass of the containers, and to reduce the environmental impact of the containers, the containers may include internal ribs formed from a plurality of arc cuts in sidewalls of unribbed containers. In at least one embodiment, the arc cuts are formed by removing material from the interior surfaces of the unribbed containers. In various embodiments, the arc cuts extend from the wall of the container to the bottom of the container.

### Exemplary Embodiments

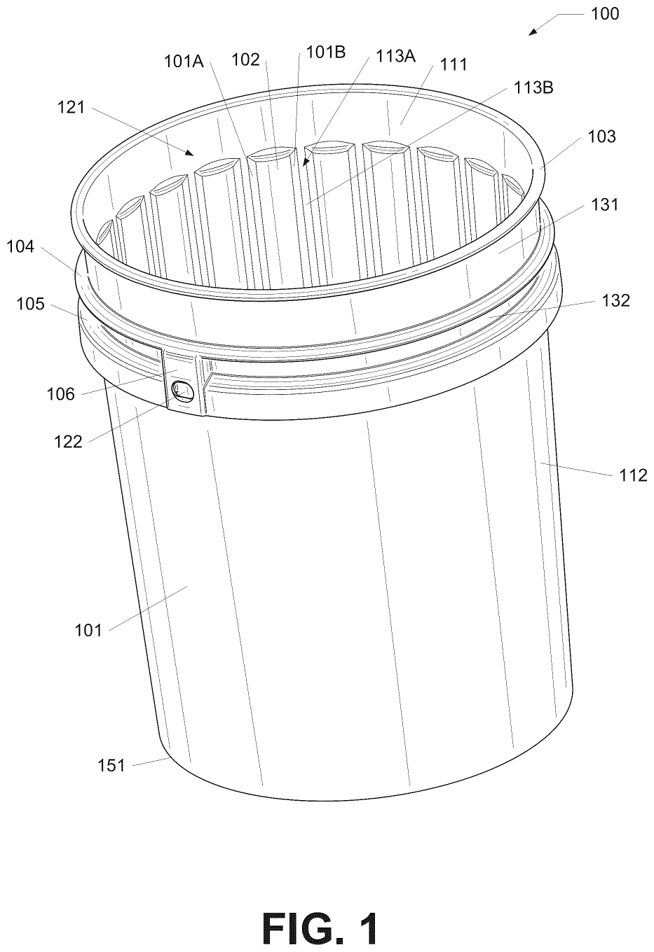

Referring now to the figures, for the purposes of example and explanation of the fundamental processes and components of the disclosed systems and processes, reference is made to FIG. 1, which illustrates a container 100. As will be understood and appreciated, the container 100 shown in FIG. 1 represents merely one approach or embodiment of the present system, and other aspects are used according to various embodiments of the present system.

In some embodiments, the container 100 holds any particular item, liquid, and/or material. The container 100 may hold, for example, recycled material, paint, water, compost, trash, any other item, or a combination thereof. In one or more embodiments, the container 100 is manufactured from plastic, metal, ceramic, or any suitable material. For example, the container 100 may be manufactured from polyethylene terephthalate (PTE). In at least one embodiment, the container 100 is produced using any adequate manufacturing process. For example, the container 100 may be created using press molding, injection molding, additive manufacturing techniques, or any other suitable process.

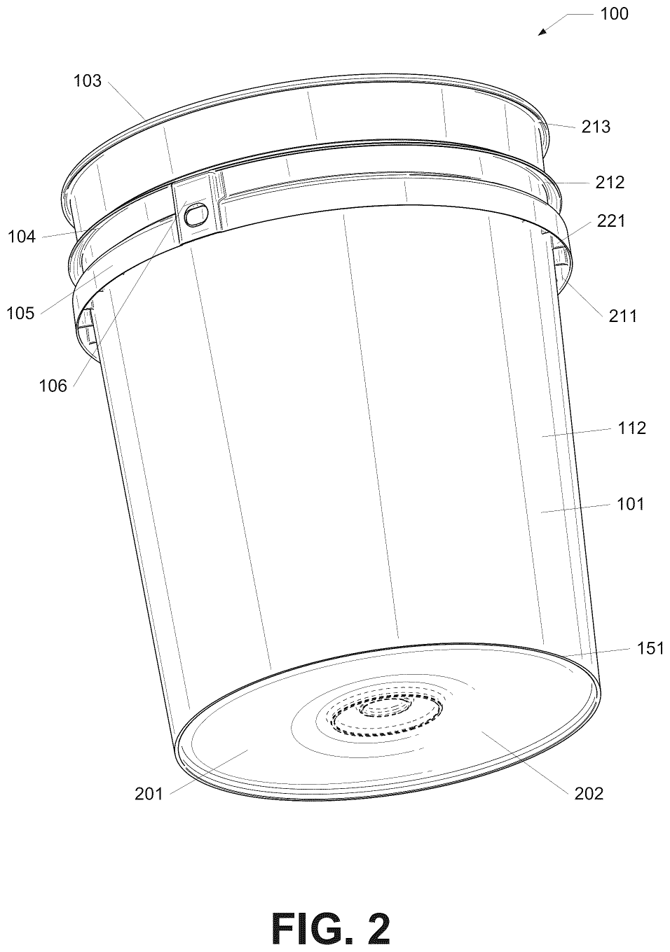

In certain embodiments, the container 100 includes a container sidewall 101, an opening aperture 121, and a bottom 201, as described in detail below with respect to FIG. 2. In one or more embodiments, the opening aperture 121 facilitates access to the container 100. For example, items may be placed for storage through the opening aperture 121 into the container 100. The container sidewall 101 may connect to the bottom 201. In various embodiments, the bottom 201 and the container sidewall 101 connect at a bottom perimeter 151. In various embodiments, the container sidewall 101 extends vertically from the bottom 201 and the bottom perimeter 151.

In particular embodiments, the container sidewall 101 includes an interior surface 111 and an exterior surface 112. In some embodiments, the exterior surface 112 is substantially smooth. The interior surface 111 may include vertical arc cuts 102 and vertical ribs 113A. In one or more embodiments, the vertical arc cuts 102 are sections of the container 100 where the container thickness is reduced. For example, the container thickness may be defined as the distance between the interior surface 111 and the exterior surface 112. In at least one embodiment, a thickness of the vertical arc cuts 102 is substantially less at a center of the vertical arc cuts 102 than at other locations of the container 100. In various embodiments, the vertical arc cuts 102 are manufactured by removing material from the interior surface 111. In particular embodiments, the surfaces of the vertical arc cuts 102 are rounded and have varying degrees of thickness. For example, the center of the vertical arc cut 102 may have a thickness that is less than border locations of the vertical arc cut 102 that begin to form the protrusion of the vertical ribs 113A. In some embodiments, reducing the thickness of the container sidewall 101 by incorporating the vertical arc cuts 102 decreases the mass and total material cost of the container 100 while still maintaining the structural integrity of the container 100.

In some embodiments, the border of the vertical arc cuts 102 include a first transition region 101A and a second transition region 101B. The transition regions 101A-B may mark the locations where the vertical arc cut 102 transitions to the vertical rib 113A. In various embodiments, the transition regions 101A-B are substantially smooth and blend the connection between the vertical arc cuts 102 and the vertical ribs 113A. In one or more embodiments, the vertical ribs 113A are spacers dividing the vertical arc cuts 102. In some embodiments, portions of the vertical ribs 113A are a thickness of the container sidewall 101. For example, the vertical ribs 113A can include vertical rib peaks 113B. The vertical rib peaks 113B may demarcate the positions with greatest thickness on the container sidewall 101. In particular embodiments, the vertical arc cuts 102 and the vertical ribs 113A are equally spaced. In at least one embodiment, the vertical arc cuts 102 do not extend for a full height of the container 100. In various embodiments, the vertical ribs 113A extend the full height of the container 100.

In certain embodiments, the container sidewall 101 includes a container bead 103. The container bead 103 may be used to seal the container 100 when a removable lid is affixed to the container 100. The container bead 103 may be rounded and may include an extending edge that extends over the container sidewall 101.

In various embodiments, the outer surface 112 includes a middle satellite ring 104, a bottom satellite ring 105, and a bail ear 106. In some embodiments, the container bead 103 and the middle satellite ring 104 is divided by a first recess 131. In particular embodiments, the middle satellite ring 104 and the bottom satellite ring 105 are divided by a second recess 132. The bail ear 106 may facilitate attaching a holding apparatus (not pictured) through an ear aperture 122. In some embodiments, the bail ear 106 has an identical ear 106 on the opposing side of the container 100. In various embodiments, the ear aperture 122 of the first bail ear 106 receives a first end of the holding apparatus, while the ear aperture 122 of the second bail ear 106 receive the opposite end of the holding apparatus. In one or more embodiments, the ends of the holding apparatus lock into the bail ears 106. As the container 100 is hoisted from the holding apparatus, the bail ears 106 support the weight of the container 100 and all of its content.

Referring now to FIG. 2, illustrated is a bottom perspective view of the container 100, according to one embodiment of the present disclosure. In one or more embodiments, the container sidewall 101 and the bottom 201 connect at the bottom perimeter 151. In particular embodiments, the container sidewall 101 and the bottom 201 are manufactured as one individual component. In various embodiments, the bottom 201 includes an exterior surface 202 of the bottom 201.

In some embodiments, the container sidewall 101 includes the container bead 103, the middle satellite ring 104, and the bottom satellite ring 105. In various embodiments, the container bead 103, the middle satellite ring 104, and the bottom satellite ring 105 protrude from the exterior surface 112. The container bead 103 may include a gap 213. In at least one embodiment, the gap 213 is produced by the container bead 103, as the container bead 103 extends outward over the exterior surface 112. The container bead 103 may be used to seal the container 100 when a removable lid is affixed to the container 100. In various embodiments, the container bead 103 produces a gripping location for holding and tilting the container 100. For example, a user may place the ends of their fingers into the gap 213 to support the weight of the container 100 and its content. In certain embodiments, the middle satellite ring 104 and the bottom satellite ring 105 produce a buffer region between two or more adjacent containers 100. For example, when a first container 100 is placed next to a second container 100, the satellite rings 104 and 105 of both containers 100 may contact to create a separation region. In multiple embodiments, the separation region between two or more adjacent containers 100 can facilitate maximizing the number of containers 100 that can be placed in a single area.

In various embodiments, the middle satellite ring 104 and the bottom satellite ring 105 include a second gap 212 and a third gap 211, respectively. In some embodiments, the middle satellite ring 104 partially extends towards the bottom 201. The middle satellite ring 104 may provide a holding position through the second gap 212. In various embodiments, the bottom satellite ring 105 extends toward the bottom 201 and provides the third gap 211. In some embodiments, the bottom satellite ring 105 extends perpendicularly from the exterior surface 112 and transitions to a parallel configuration relative to the exterior surface 112. In at least one embodiment, the third gap 211 may include ring fins 221. The ring fins 221 may extend from the exterior surface 112 to the bottom satellite ring 105. In various embodiments, the ring fins 221 may connect to the exterior surface 112 and the bottom satellite ring 105. The ring fins 221 may be equally spaced and distributed around the container 100. In one or more embodiments, the ring fins 221 provide structural integrity to the container 100, the bottom satellite ring 105, and the bail ear 106. In one or more embodiments, the bottom satellite ring 105, the middle satellite ring 104, or a combination thereof protrude at similar distances from the container sidewall 101. In particular embodiments, the bottom satellite ring 105, the middle satellite ring 104, or a combination thereof protrude at dissimilar distances from the container sidewall 101.

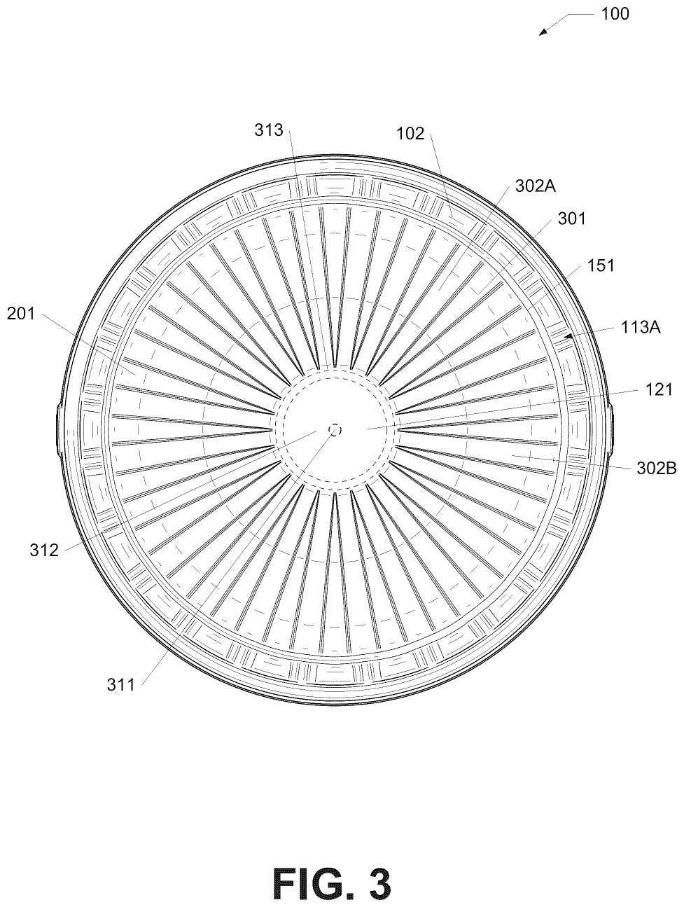

Referring now to FIG. 3, illustrated is a top view of the container 100, according to one embodiment of the present disclosure. In some embodiments, the bottom 201 includes a central axis 311, a bottom dome 312, and a dome edge 313. In various embodiments, the central axis 311 extends through the center of the container 100 in a direction perpendicular to a plane formed along the bottom 201 of the container 100.

In certain embodiments, the bottom dome 312 is an elevated dome structure centered about the central axis 311. The bottom dome 312 may have a substantially rounded surface. In multiple embodiments, the bottom dome 312 transitions continuously along the bottom 201. For example, the bottom dome 312 protrudes from the bottom 201 in a continuous manner from the surrounding surfaces. In at least one embodiment, the dome edge 313 marks the transition region from the bottom dome 312 to the remaining portion of the bottom 201.

The bottom 201 may include horizontal arc cuts 301 and horizontal ribs 302A. The horizontal arc cuts 301 and the horizontal ribs 302A may extend from the bottom perimeter 151 to the dome edge 313. In various embodiments, the horizontal arc cuts 301 are formed in a manner that is substantially similar to the vertical arc cuts 102. In one or more embodiments, the width of the horizontal arc cuts 301 decrease as they approach the central axis 311. For example, as the sides of the horizontal arc cuts 301 approach the dome edge 313, the sides of the horizontal arc cuts 301 converge to one point on the dome edge 313.

Continuing this example, the horizontal arc cuts 301 may form a circular sector shape. In various embodiments, the sides of the horizontal ribs 302A may remain parallel with one another as the horizontal ribs 302A extend from the bottom perimeter 151 to the dome edge 313. For example, the horizontal ribs 302A may form a trapezoidal or rectangular shape. In one or more additional embodiments, the shape of the horizontal ribs 302A may be a circular sector shape, and the sides of the horizontal arc cuts 301 may be parallel with one another to establish a trapezoidal or rectangular shape.

In at least on embodiment, the thickness of the bottom 201 is less at the horizontal arc cuts 301 than the horizontal ribs 302A. In some embodiments, reducing the material used for the bottom 201 by integrating horizontal arc cuts 301 decreases the mass and material cost of the container 100 while still maintaining the structural integrity of the bottom 201. The horizontal ribs 302A may include horizontal rib peaks 302B. The horizontal rib peak 302B may define the thickest portion of the horizontal rib 302A. In various embodiments, the horizontal arc cuts 301 align with the vertical arc cuts 102. For example, one particular vertical arc cut 102 couples to the bottom perimeter 151 at a corresponding horizontal arc cut 301. In some embodiments, the vertical ribs 113A align with the horizontal ribs 302A. For example one particular vertical rib 113A couples to the bottom perimeter 151 at a corresponding horizontal rib 302A. In an additional embodiment, the horizontal ribs 302A may align with the vertical arc cuts 102 and the horizontal arc cuts 301 may align with the vertical ribs 113A. In some embodiments, the horizontal ribs 302A may divide the horizontal arc cuts 301. For example, two horizontal arc cuts 301 are separated by a horizontal rib 302A.

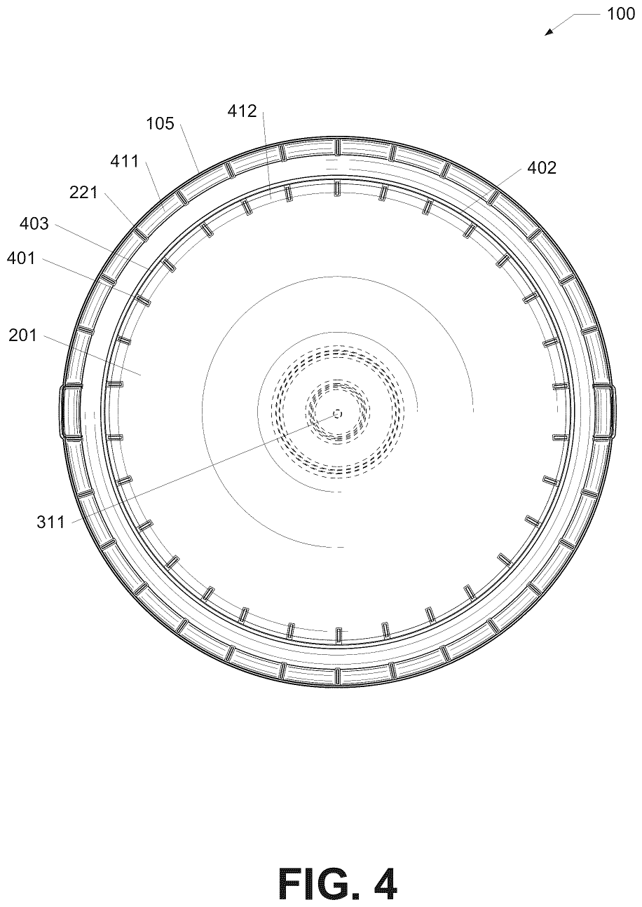

Referring now to FIG. 4, illustrated is a bottom view of the container 100, according to one embodiment of the present disclosure. In various embodiments, the bottom 201 includes bottom fins 401. In particular embodiments, the bottom fins 401 extend from the bottom 201 to a bottom rim 402. In at least one embodiment, the bottom fins 401 extend from the interior bottom perimeter 403 in a direction perpendicular to the central axis 311. In one or more embodiments, the bottom rim 402 extends from the bottom 201 in a direction that continues the conical frustum of the container 100. In an additional embodiment, the bottom rim 402 extends perpendicularly from the bottom 201. The bottom rim 201 may provide structural integrity to the container 100 and may reduce the amount of contact between the bottom 201 and any particular surface the container 100 is placed.

In some embodiments, the bottom fins 401 are shaped as a quadrant. A quadrant may be defined as a shape that represents a quarter of an oval. In an additional example, the quadrant may be a shape that represents a quarter of a circle (e.g., 90 degrees of a circle). In at least one embodiment, the bottom fins 401 provide structural integrity to the bottom 201, the bottom rim 402, and the container 100. The bottom fins 401 may define bottom spaces 412. In some embodiments, the bottom spaces 412 may be located between each consecutive bottom fin 401. In particular embodiments, the bottom spaces 412 are equal in dimensionality and are distributed equally along the perimeter of the bottom 201. In particular embodiments, the bottom satellite ring 105 includes ring spaces 411. In one or more embodiments, the ring spaces 411 may be located between each consecutive ring fin 221. In at least one embodiment, the ring spaces 411 are equal in dimensionality.

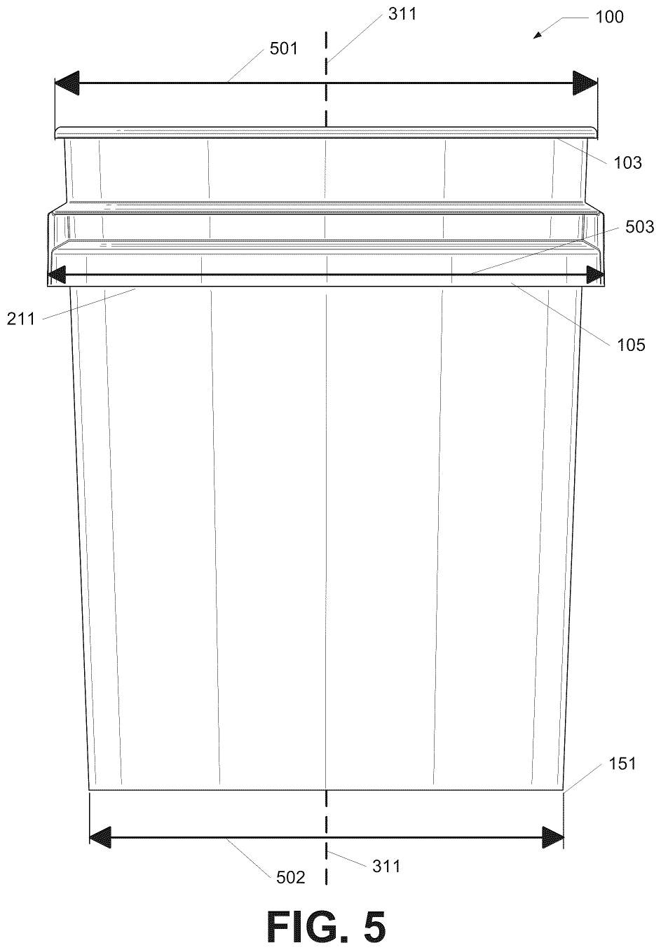

Referring now to FIG. 5, illustrated is a first side view of the container 100, according to one embodiment of the present disclosure. In various embodiments, the container 100 includes an opening diameter 501, a bottom diameter 502, and a bottom ring diameter 503. In at least one embodiment, the opening diameter 501 may measure at least about 11.0 in. In some examples, the opening diameter 501 may be between 11.0-13.0 in, 11.0-12.0 in, 12.0-13.0 in, or less than about 13.0 in. In an example where the container 100 is a five-gallon container, the opening diameter 501 may be 11.9 inches. In one or more embodiments, the bottom diameter 502 measures at least about 10.0 in. In some examples, the bottom diameter 502 may measure between 10.0-12.0 in, 10.0-11.0 in, 11.0-12.0 in, or less than about 12.0 in. In an example where the container 100 is a five-gallon container, the bottom diameter 501 may be 10.4 inches. In various embodiments, the opening diameter 501 is larger than the bottom diameter 502. In other words, a distance from the container bead 103 to the central axis 311 is greater than a distance from the bottom perimeter 151 to the central axis 311. In particular embodiments, two or more containers 100 are stackable when the bottom diameter 502 is smaller than the opening diameter 501. In some embodiments, the shape of the container 100 is substantially similar to a conical frustum.

In at least one embodiment, the bottom satellite ring 105 includes a ring diameter 503. In various embodiments, the ring diameter 503 is larger than the opening diameter 501. In various embodiments, a container bead 103 of another container 100 may fit under the third gap 211 of the bottom satellite ring 105. For example, if a first container 100 is stacked above a second container 100, the container bead 103 of the second container 100 may fit below the bottom satellite ring 105 of the first container 100 within the third gap 211 of the first container 100.

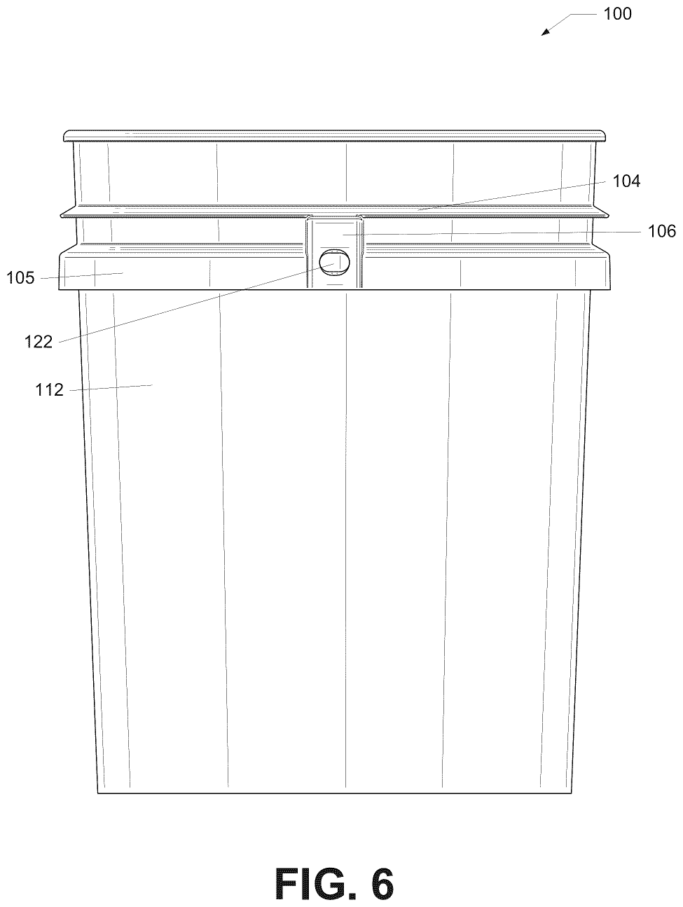

Referring now to FIG. 6, illustrated is a second side view of the container 100, according to one embodiment of the present disclosure. In at least one embodiment, the bail ears 106 protrude from the exterior surface 112. In some embodiments, the bail ears 106 provide an attachment point for fixing a carrying tool to the container 100. For example, each end of the carrying tool may fix to the ear apertures 122. Continuing this example, when lifted from the carrying tool, the container 100 and its content can hang from the carrying tool by exerting a holding force through the bail ears 106. In various embodiments the bail ears 106 connect to the middle satellite ring 104 and the bottom satellite ring 105. In at least one embodiment, connecting the bail ears 106 to the middle satellite ring 104 and the bottom satellite ring 105 increases the structural integrity of the bail ears 106. For example, when a force is exerted on the bail ears 106 from lifting the container 100 using a carrying tool, the bail ears 106 can distribute the force throughout the middle satellite ring 104 and the bottom satellite ring 105. The bail ears 106 may protrude further from the surface 112 than the middle satellite ring 104 and the bottom satellite ring 105. In some embodiments, the bail ears 106 include the ear aperture 122. In certain embodiments, the ear aperture 122 is substantially circular or oval.

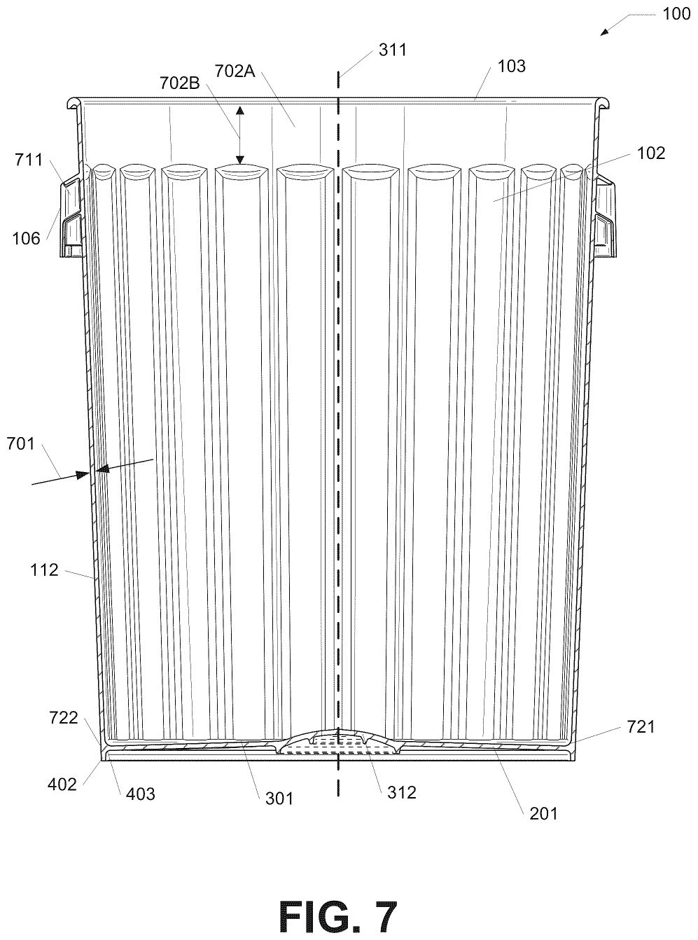

Referring now to FIG. 7, illustrated is a first cross section view of the container 100, according to one embodiment of the present disclosure. In various embodiments, the container 100 includes an arc cut thickness 701, an arc cut gap 702A, and a gap length 702B. In particular embodiments, the arc cut thickness 701 measures at least about 65.0 mil, 65.0-85.0 mil, 65.0-75.0 mil, 75.0 mil, 75.0-85.0 mil, or less than about 85.0 mil. In various embodiments, the arc cut gap 702A is a surface with constant thickness that divides the container bead 103 from the vertical arc cuts 102. In one or more embodiments, the gap length 702B measure at least about 1.0 inches, 1.0-2.0 inches, 1.0-1.5 inches, 1.461 inches, 1.5-2.0 inches, or less than about 2 inches.

In at least one embodiment, the bail ears 106 include an ear space 711. In some embodiments, the ear space 711 is empty space behind the bail ear 106. In one or more embodiments, the ear space 711 facilitates inserting and locking a handle apparatus for carrying the container 100.

In various embodiments, the bottom 201 has a substantially similar variation in thickness as the container sidewall 101. In various embodiments, the horizontal arc cuts 301 have a substantially similar thickness to the arc cut thickness 701. In multiple embodiments, the bottom dome 312 protrudes from the bottom 201.

The container 100 may include the bottom rim 402. In one or more embodiments, the bottom rim 402 extends perpendicularly form the bottom 201. In at least one embodiment, the bottom fins 401 extend from the interior bottom perimeter 403 in a direction perpendicular to the central axis 311. In one or more embodiments, the bottom rim 402 may extend from the bottom 201 in a direction that continues the conical frustum of the container 100. In some embodiments, the bottom rim 402 reduces the contact of the bottom 201 and any particular surface the container 100 is placed. In one or more embodiments, the bottom 201 includes an interior bottom perimeter 721 and an exterior bottom perimeter 722. In various embodiments, the exterior surface 112 extends from the exterior bottom perimeter 722 to the container bead 103. In particular embodiments, the interior surface 101 extends from the interior bottom perimeter 721 to the container bead 103.

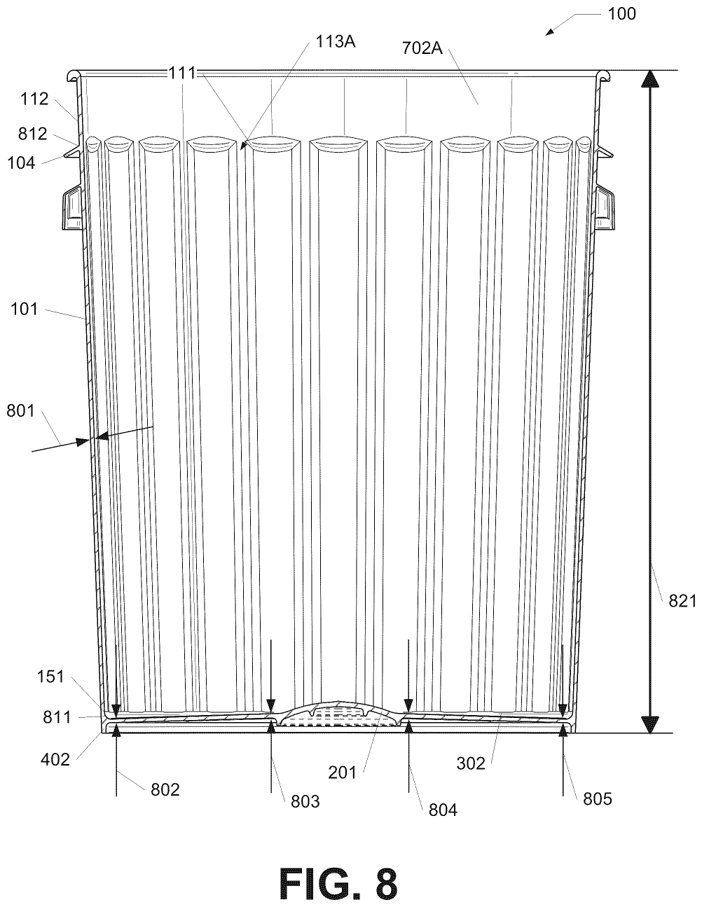

Referring now to FIG. 8, illustrated is a second cross section view of the container 100, according to one embodiment of the present disclosure. In at least one embodiment, the container 100 includes a container thickness 801, a first bottom thickness 802, a second bottom thickness 803, a third bottom thickness 804, and a fourth bottom thickness 805. In various embodiments, the container thickness 801 defines the thickness for the vertical ribs 113A, the horizontal ribs 302A, the arc cut gap 702A, and the bottom rim 402. The container thickness 801 may measure at least about 70.0 mil, 70.0-110.0 mil, 70.0-80.0 mil, 80.0-90.0 mil, 90.0 mil, 90.0-100.0 mil, 100.0-110.0 mil, or less than about 110.0 mil. The first bottom thickness 802 may measures at least about 65.0 mil, 65.0-85.0 mil, 65.0-76.0 mil, 76.0 mil, 76.0-85.0 mil, or less than about 85.0 mil. The second bottom thickness 803 may measure at least about 70.0 mil, 70.0-110.0 mil, 70.0-80.0 mil, 80.0-90.0 mil, 97.0 mil, 90.0-100.0 mil, 100.0-110.0 mil, or less than about 110.0 mil. The third bottom thickness 804 may measure at least about 70.0 mil, 70.0-110.0 mil, 70.0-80.0 mil, 80.0-90.0 mil, 98.0 mil, 90.0-100.0 mil, 100.0-110.0 mil, or less than about 110.0 mil. The fourth bottom thickness 805 may measure at least about 70.0 mil, 70.0-110.0 mil, 70.0-80.0 mil, 80.0-90.0 mil, 98.0 mil, 90.0-100.0 mil, 100.0-110.0 mil, or less than about 110.0 mil.

In various embodiments, the container 100 includes a bottom radius 811 and a middle ring radius 812. In some embodiments, the bottom radius 811 defines the curve applied to the bottom perimeter 151 between interior surface 111 of the sidewall 101 and the bottom 201. In one or more embodiments, the bottom radius 811 measures at least about 0.10 in, 0.10-0.20 inches, 0.10-0.15 inches, 0.156 inches, 0.15-0.20 inches, or less than about 0.20 inches. In particular embodiments, the middle ring radius 812 defines the rounded surface between the middle satellite ring 104 and the exterior surface 112. In one or more embodiments, the middle ring radius 812 measures at least about 1.0 inches, 1.0-3.0 inches, 1.0-2.0 inches, 2.0 inches, 2.0-3.0 inches, or less than about 3.0 inches.

In some embodiments, the container 100 extends a container height 821. In various embodiments, the container height 821 measures the height of the container 100. The container height 821 may measure at least about 12.0 inches, 12.0-16.0 inches, 12.0-14.0 inches, 14.462 inches, 14.0-16.0 inches, or less than about 16.0 inches.

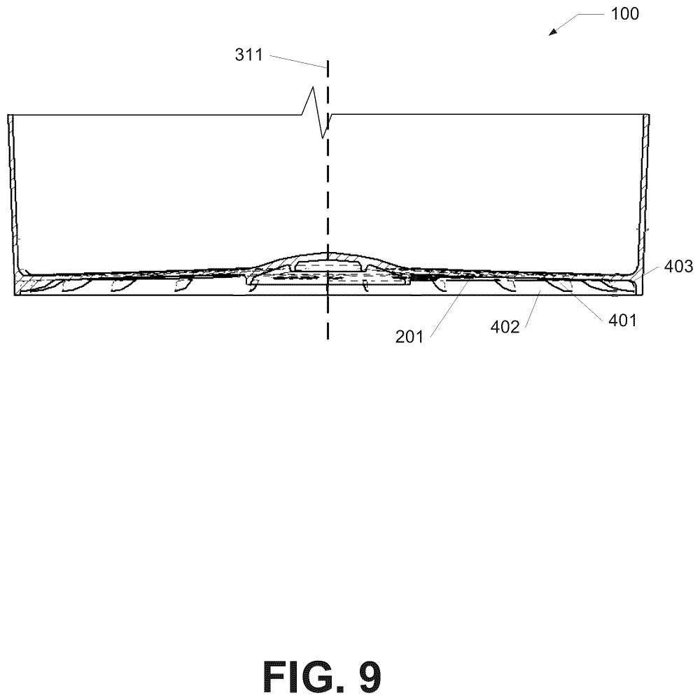

Referring now to FIG. 9, illustrated is a cross section view of the bottom 201 of the container 100, according to one embodiment of the present disclosure. In one or more embodiments, the bottom fins 401 extend from the bottom rim 402 to the bottom 201. In one or more embodiments, the bottom rim 402 extends perpendicularly form the bottom 201. In at least one embodiment, the bottom fins 401 extend from the interior bottom perimeter 403 in a direction perpendicular to the central axis 311. In one or more embodiments, the bottom rim 402 extends from the bottom 201 in a direction that continues the conical frustum of the container 100. In particular embodiments, the bottom fins 401 are shaped as quadrants of an oval and are equally distributed around the base 201. In additional examples, the quadrant may be a shape that represents a quarter of a circle (e.g., 90 degrees of a circle).

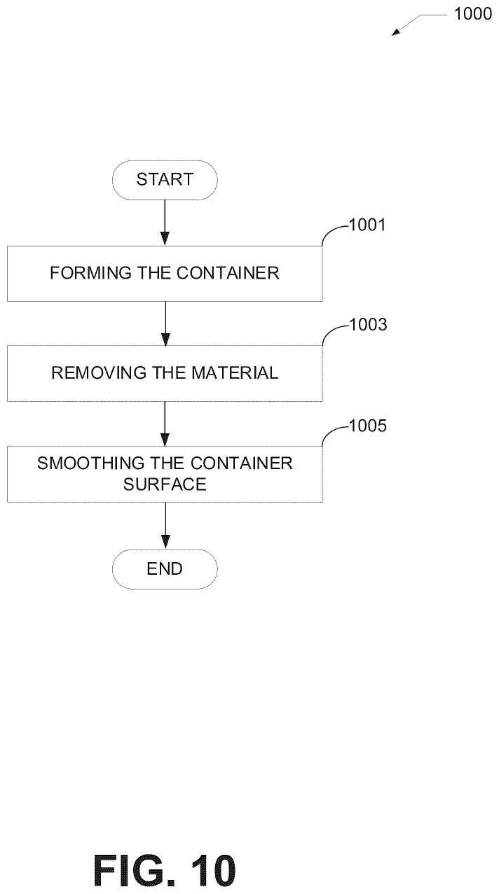

Referring now to FIG. 10, illustrated is a flowchart of a process 1000 depicting a method of manufacturing the container 100, according to one embodiment of the present disclosure. In some embodiments, the container 100 resulting from the process 1000 reduces a material cost of manufacturing by up to ten or more percent compared to an unribbed container. Employing vertical arc cuts 102 may reduce the mass of the container 100 while maintaining the structural integrity of the container 100. In various embodiments, an unribbed container formed at block 1001 may have a mass of approximately 940 grams, while the container 100 resulting from the process 1000 may have a mass of approximately 855 grams.

At block 1001, the process 1000 includes forming an unribbed container, according to one embodiment of the present disclosure. Forming the unribbed container may include any method for forming the unribbed container using any applicable material. In some embodiments, the container 100 is made from plastic, metal, ceramic, or any other applicable material. In at least one embodiment, the container 100 is formed using any appropriate forming technique. Appropriate forming techniques may include, but are not limited to, press molding, injection molding, additive manufacturing techniques, or any other suitable process.

At block 1003, the process 1000 includes applying a plurality of equally spaced vertical arc cuts 102 to an interior surface of a sidewall of the unribbed container, according to one embodiment of the present disclosure. In some examples, a plurality of horizontal arc cuts 301 may also be applied to a bottom of the unribbed container.

In various embodiments, the interior surface of the unribbed container is cut using an initial cutting mechanism, such as a precision computer numerical control (CNC) machine, with an initial radius of at least about 1.0 inch. The initial radius may measure the arc cut radius of the vertical arc cuts 102 nearest to the container bead 103. In some examples, the initial radius of the vertical arc cuts 102 may be between 1.0-2.0 inches, 2.0-3.0 inches, 3.0-4.0 inches, or less than about 4.0 inches. In an example where the unribbed container is a five-gallon container, the initial radius of the vertical arc cuts 102 may be 3.481 inches. In various embodiments the initial cutting machine, such as a precision CNC machine, continues cutting the vertical arc cuts 102 along the sidewall of the unribbed container. For example, the initial cutting mechanism begins at a point nearest to the container bead 103 and continues to the base of the unribbed container. Continuing this example, the initial cutting mechanism continuously cuts the sidewall of the unribbed container as the initial cutting mechanism progresses along the interior surface of the unribbed container. In particular embodiments, the initial cutting mechanism reduces the initial cutting radius along the sidewall of the unribbed container as the cutting mechanism approaches the bottom perimeter of the unribbed container. In this embodiment, the cutting radius approaches a final cutting radius at the interior bottom perimeter of the unribbed container. In at least one embodiment, the final radius measures at least about 0.5 inches. In some examples, the final radius measures 0.5-1.5 inches, 1.5-2.5 inches, 2.5-3.5 inches, or less than about 3.5 inches. In an example where the unribbed container is a five-gallon container, the final radius may measure 3.038 inches.

The initial cut may remove a predetermined amount of material without altering the structural integrity of the container 100. For example, the initial vertical arc cuts 102 may be produced while maintaining a desired width of the vertical ribs 113A. In at least one embodiment, the vertical arc cuts 102 and the horizontal arc cuts 301 facilitate removing material from the unribbed container to reduce materials costs associated with manufacturing the container 100, reduce the environmental impact of the container 100, reduce the mass of the container 100, or any combination thereof.

In various embodiments, the container 100 is blended with a 15 inch radial cutting mechanism, such as a precision CNC machine, which forms a smooth transition between the initial vertical arc cuts 102 and the vertical ribs 113A along the interior surface 111. For example, the 15 inch radial cutting mechanism is passed over the initial vertical arc cut 102 to blend the surface of the vertical arc cuts 102 into the interior surface 111. Continuing this example, the 15 inch radial cutting mechanism blends the vertical arc cuts 102 and the vertical ribs 113A together to produce a substantially smooth surface.

In particular embodiments, the combined cutting mechanism may remove approximately 15 mil of material for each vertical arc cut 102 formed. For example, the wall thickness of the container 100 may be 75 mil at the vertical arc cut 102, while the wall thickness at a vertical rib peak 113B may be 90 mil. In one or more embodiments, the minimum thickness difference between the vertical rib 113A and the vertical arc cut 102 is at least 15 mil. In at least one embodiment, the horizontal ribs 302A and the horizontal arc cuts 301 exhibit the same characteristics. The container 100 may include 24 vertical arc cuts 102. In various embodiments, the container 100 includes any number of vertical arc cuts 102 with varying lengths, depths, and radii.

At block 1005, the process 1000 includes applying a vertical blending cut to each intersection between the equally spaced vertical arc cuts 102 and the vertical rib peaks 113B of the vertical ribs 113A, according to one embodiment of the present disclosure. A similar blending operation may be applied to the horizontal arc cuts 301. In various embodiments, the arc cuts 102 and 301 are blended to form a smooth transition between the arc cuts 102 and 301 and the peaks of the ribs 113A and 302A within the container 100. In other words, the blending cuts applied to the interior surface 111 and the bottom 201 may generate undulating sidewall and bottom profiles with smooth transitions between the ribs 113A and 302A and the arc cuts 102 and 301.

### CONCLUSION

Accordingly, it will be readily understood by those persons skilled in the art that, in view of the above detailed description of the various embodiments and articles of the present disclosure, the present disclosure is susceptible of broad utility and application. Many methods, embodiments, and adaptations of the present disclosure other than those herein described, as well as many variations, modifications, and equivalent arrangements will be apparent from or reasonably suggested by the present disclosure and the above detailed description thereof, without departing from the substance or scope of the present disclosure. Accordingly, while the present disclosure is described herein in detail in relation to various embodiments, it is to be understood that this detailed description is only illustrative and exemplary of the present disclosure and is made for purposes of providing a full and enabling disclosure of the present disclosure. The detailed description set forth herein is not intended nor is to be construed to limit the present disclosure or otherwise to exclude any such other embodiments, adaptations, variations, modifications, and equivalent arrangements of the present disclosure. The scope of the present disclosure is defined solely by the claims appended hereto and the equivalents thereof.

What is claimed is:

1. A container comprising:
a bottom comprising a bottom surface and a bottom perimeter, the bottom perimeter at a first distance from a central axis of the bottom surface;
a sidewall extending vertically from the bottom perimeter at the first distance from the central axis that is perpendicular to the bottom surface to a container bead at a second distance from the central axis of the bottom surface, wherein the sidewall comprises:
an outside surface of the sidewall, the outside surface comprising a smooth surface; and
an interior surface of the sidewall, the interior surface comprising a plurality of vertical ribs extending vertically from the bottom perimeter, wherein each vertical rib of the plurality of vertical ribs comprises:
a first vertical arc cut in the sidewall that forms a first side of the vertical rib; and
a second vertical arc cut in the sidewall that forms a second side of the vertical rib opposite the first side of the vertical rib.

2. The container of claim 1, wherein each vertical rib of the plurality of vertical ribs further comprises:
a vertical rib peak positioned between the first vertical arc cut and the second vertical arc cut;
a first vertical blended section positioned between the vertical rib peak and the first vertical arc cut and configured to smooth a first transition from the first vertical arc cut and the vertical rib peak; and
a second vertical blended section positioned between the vertical rib peak and the second vertical arc cut and configured to smooth a second transition from the second vertical arc cut to the vertical rib peak.

3. The container of claim 2, wherein the sidewall at a minimum thickness of the first vertical arc cut is at least 15 mil thinner than the sidewall at the vertical rib peak.

4. The container of claim 2, wherein the bottom surface comprises a plurality of horizontal ribs, wherein each horizontal rib of the plurality of horizontal ribs comprises:
a first horizontal arc cut in the bottom surface that forms a first side of the horizontal rib; and
a second horizontal arc cut in the bottom surface that forms a second side of the horizontal rib opposite the first side of the horizontal rib.

5. The container of claim 4, wherein each horizontal rib of the plurality of horizontal ribs further comprises:
a horizontal rib peak positioned between the first horizontal arc cut and the second horizontal arc cut;
a first horizontal blended section positioned between the horizontal rib peak and the first horizontal arc cut and configured to smooth a first transition from the first horizontal arc cut and the horizontal rib peak; and
a second horizontal blended section positioned between the horizontal rib peak and the second horizontal arc cut and configured to smooth a second transition from the second horizontal arc cut to the horizontal rib peak.

6. The container of claim 5, wherein a first horizontal rib of the plurality of horizontal ribs aligns with the first vertical arc cut of the sidewall at an intersection of the bottom surface and the interior surface of the sidewall.

7. The container of claim 5, wherein each horizontal rib of the plurality of horizontal ribs aligns with a vertical rib of the plurality of vertical ribs at an intersection of the bottom surface and the interior surface of the sidewall.

8. The container of claim 5, wherein the first horizontal arc cut and a portion of the bottom perimeter between sides of the first horizontal arc cut form a circular sector shape.

9. The container of claim 8, wherein a second surface opposite the bottom surface comprises a plurality of fins extending from the bottom perimeter in a direction perpendicular to the central axis.

10. The container of claim 1, wherein the second distance from the central axis is greater than the first distance of the central axis such that the sidewall forms a conical frustum.

11. A method of manufacturing a ribbed container comprising:
molding an unribbed container, the unribbed container comprising:
a bottom comprising a bottom surface and a bottom perimeter, the bottom perimeter at a first distance from a central axis of the bottom surface; and
a sidewall extending vertically from the bottom perimeter at the first distance from the central axis that is perpendicular to the bottom surface to a container bead at a second distance from the central axis of the bottom surface;
applying a plurality of equally spaced vertical arc cuts to an interior surface of the sidewall to generate a plurality of vertical ribs comprising a vertical rib peak on the interior surface of the sidewall; and
applying a vertical blending cut to each intersection between the plurality of vertical arc cuts and a plurality of vertical rib peaks of the plurality of vertical ribs.

12. The method of manufacturing the ribbed container of claim 11, wherein the plurality of vertical arc cuts comprise a first radius, and wherein the vertical blending cut comprises a second radius, wherein the first radius is smaller than the second radius.

13. The method of manufacturing the ribbed container of claim 11, further comprising:
applying a plurality of horizontal arc cuts to the bottom surface of the unribbed container, wherein the plurality of horizontal arc cuts extend from the bottom perimeter in toward the central axis of the bottom surface.

14. The method of manufacturing the ribbed container of claim 11, wherein the sidewall at a minimum thickness of each of the plurality of vertical arc cuts is at least 15 mil thinner than the sidewall at the vertical rib peak.

15. The method of manufacturing the ribbed container of claim 11, wherein the ribbed container comprises at least 5 percent less material than the unribbed container.

16. A container comprising:
an interior bottom perimeter;
an exterior bottom perimeter;
a top container edge;
a first sidewall section extending from the exterior bottom perimeter to the top container edge, wherein the first sidewall section comprises a smooth surface; and
a second sidewall section extending from the interior bottom perimeter to the top container edge, wherein the second sidewall section comprises a plurality of vertical ribs extending vertically from the interior bottom perimeter toward the top container edge, wherein each vertical rib of the plurality of vertical ribs comprises:
a first vertical arc cut in the second sidewall section that forms a first side of the vertical rib;
a second vertical arc cut in the second sidewall section that forms a second side of the vertical rib opposite the first side of the vertical rib;
a vertical rib peak positioned between the first vertical arc cut and the second vertical arc cut;
a first vertical blended section positioned between the vertical rib peak and the first vertical arc cut and configured to smooth a first transition from the first vertical arc cut and the vertical rib peak; and
a second vertical blended section positioned between the vertical rib peak and the second vertical arc cut and configured to smooth a second transition from the second vertical arc cut to the vertical rib peak.

17. The container of claim 16, further comprising:
a bottom positionable within the interior bottom perimeter, the bottom comprising an interior surface coupled to the second sidewall section and an exterior surface opposite the interior surface, wherein the exterior surface of the bottom comprises a smooth surface, and wherein the interior surface of the bottom comprises a plurality of horizontal ribs, wherein each horizontal rib of the plurality of horizontal ribs comprises:
a first horizontal arc cut in the interior surface of the bottom that forms a first side of the horizontal rib; and
a second horizontal arc cut in the interior surface of the bottom that forms a second side of the horizontal rib opposite the first side of the horizontal rib.

18. The container of claim 17, wherein the exterior surface of the bottom comprises a plurality of fins extending from the interior bottom perimeter in a direction perpendicular to a central axis that is perpendicular to the bottom.

19. The container of claim 16, wherein a minimum thickness of the first vertical arc cut is at least 15 mil thinner than a thickness at the vertical rib peak.

20. The container of claim 16, wherein the first sidewall section forms a conical frustum.
